(19) United States
(12) Patent Application Publication
(10) Pub. No.: US 2015/0035199 A1
(43) Pub. Date: Feb. 5, 2015

(54) METHOD FOR PRODUCING AROMATIC POLYIMIDE FILM WHEREIN LINEAR EXPANSION COEFFICIENT IN TRANSVERSE DIRECTION IS LOWER THAN LINEAR EXPANSION COEFFICIENT IN MACHINE DIRECTION

(71) Applicant: UBE INDUSTRIES, LTD., Ube-shi (JP)

(72) Inventors: Takeshi UEKIDO, Yamaguchi (JP); Nobu IIZUMI, Yamaguchi (JP); Toshiyuki NISHINO, Yamaguchi (JP); Eiji MASUI, Yamaguchi (JP); Keiichi YANAGIDA, Yamaguchi (JP)

(21) Appl. No.: 14/514,576

(22) Filed: Oct. 15, 2014

Related U.S. Application Data
(63) Continuation of application No. 12/995,556, filed on Dec. 1, 2010, now abandoned.

(30) Foreign Application Priority Data
Jun. 2, 2008 (JP) 2008-144523
Nov. 28, 2008 (JP) 2008-305456

(51) Int. Cl. B29C 41/00; B29D 7/01

(52) U.S. Cl. CPC B29C 41/003; B29D 7/01; B29K 2077/10
USPC 264/216

(57) ABSTRACT

An aromatic polyimide film having a TD linear expansion coefficient lower than that MD linear expansion coefficient is produced by an industrially advantageous process which is performed under such conditions that a self-supporting aromatic polyimide precursor film having a solvent content 25-45 wt % and an imidation ratio 5-40% is prepared and stretched in the transverse direction under heating initially at 80-240° C. and the stretched self-supporting aromatic polyimide precursor film is subsequently converted to a self-supporting aromatic polyimide film by heating the precursor film at 350-580° C.

### FIELD OF THE INVENTION

The present invention relates to a process for producing aromatic polyimide film having a linear expansion coefficient in transverse direction (TD) lower than a linear expansion coefficient in machine direction (MD). In particular, the invention relates to a process for producing an aromatic polyimide film having a TD linear expansion coefficient of lower than 10×10⁻⁶ cm/cm/° C. and an MD linear expansion coefficient of 10-20×10⁶ cm/cm/° C. by easily employable simple procedures, which is favorably utilizable for manufacturing flexible printed wiring board. Recently, it has been known that the flexible printed wiring board using an aromatic polyimide substrate film is favorably mounted onto a glass substrate or a quartz substrate.

### BACKGROUND OF THE INVENTION

Recently, aromatic polyimide films having excellent heat resistance and mechanical characteristics have been employed as substrates, insulating materials or covering materials in the fields of electric and electronic devices. Although the aromatic polyimide film inherently shows a low linear expansion coefficient (coefficient of linear thermal expansion), it is required that the aromatic polyimide film to be used in the above-mentioned fields has specifically low linear expansion coefficient.

JP-A-61-264028 (Patent Publication 1) discloses a process for producing an aromatic polyimide film having an average linear expansion coefficient of about 1×10⁻⁶ to 25×10⁻⁶ cm/cm/° C. in the temperature range of about 50° C. to 300° C. and a ratio of linear expansion coefficient (MD/TD) in the range of about ⅕ to 4, starting from a polymer solution which is obtained by polymerization of a biphenyltetracarboxylic acid compound and a phenylenediamine compound. Patent Publication 1 describes that the aromatic polyimide film is obtainable by the steps of spreading the above-mentioned polymer solution on a surface of a support to form a polymer solution film, drying the polymer solution film to a solid film having a solvent content and a water content in the range of about 27-60 wt. %, separating the solid film from the support surface, drying the separated solid film at a lower tension of 100 g/mm² or lower and a temperature of about 80-250° C. to adjust the solvent content and water content to about 5-25 wt. %, and further heating the solid film at a temperature of 200-500° C. under such condition that at least one opposite side ends of the film are fixed. It is noted that Example 5 of this patent publication describes that an aromatic polyimide film having a linear expansion coefficients of 14×10⁻⁶ cm/cm/° C. (MD) and 12×10⁻⁶ cm/cm/° C. (TD) was produced by employing the following procedures: the content of volatile ingredients in the solid film prepared by the first drying procedure was adjusted to 33%, the volatile ingredient content was then reduced to 18.0% by the second drying procedure which was carried out by drying the solid film under application of a tension of 10 g/mm² in the machine direction (but no tension was applied in the transverse direction), and finally heating the thus processed solid film to an elevated temperature.

JP-A-2005-314669 (Patent Publication 2) discloses polyimide films having a thermal expansion coefficient α_{MD} (MD, film conveying direction) of 10-20 ppm/° C. (corresponding to 10-20×10⁻⁶ cm/cm/° C.) and a thermal expansion coefficient α_{TD} (TD, transverse direction) of 3-10 ppm/° C. (corresponding to 3-10×10⁻⁶ cm/cm/° C.). The working examples given in Patent Publication 2 indicate that the above-mentioned polyimide films were obtained by the steps of preparing a solution of polyamic acid (polyimide precursor) by the reaction between a diamine component comprising a combination of p-phenylenediamine and diaminodiphenyl ether and a carboxylic acid component comprising a combination of pyromellitic anhydride and 3,3′,4,4′-diphenyltetracarboxylic dianhydride in a solvent, subjecting the polyamic acid solution to an imidization procedure after addition of a chemical imidization reagent (acetic anhydride and β-picoline) to the polyamic acid solution, spreading the resulting polyimide polymer on a rotating drum heated 90° C., stretching the resulting gel film at 1.1 ratio in a running direction at 100° C. for 5 minutes, stretching further the film at 1.5 ratio at 270° C. for 2 minutes under the condition that both side ends are fixed, and furthermore heating the film at 380° C. for 5 minutes.

As described above, the above-mentioned Patent Publication 1 indicates that an aromatic polyimide film having a TD linear expansion coefficient lower than an MD linear expansion coefficient can be obtained by performing the process under the specific conditions. However, other working examples given in Patent Publication 1 indicate that aromatic polyimide films having a TD linear expansion coefficient higher than an MD linear expansion coefficient were produced under relatively analogous preparation conditions. Further, it is noted that although an aromatic polyimide film having a TD linear expansion coefficient lower than an MD linear expansion coefficient can be obtained under the specific conditions, the TD linear expansion coefficient of the obtained film is 12×10⁻⁶ cm/cm/° C. which is not so low.

As described above, the above-mentioned Patent Publication 2 indicates a process which gives a polyamide film having an MD linear expansion coefficient of 10-20×10⁻⁶ cm/cm/° C. (10-20 ppm/° C.) and a TD linear expansion coefficient of 3-10×10⁻⁶ cm/cm/° C. (3-10 ppm/° C.). It is noted, however, that the actually disclosed process for producing the above-mentioned polyamide film employs two carboxylic acid components and two diamine components and utilizes a combination of the use of a chemical imidization reagent and a heating procedure. Moreover, the stretching procedure is performed by two steps, that is, the stretching in the machine direction at 100° C. and the stretching in the transverse direction at 270° C.

As described hereinbefore, it is desired that the aromatic polyimide film favorably employable for manufacturing a flexible printed wiring board to be mounted on glass substrates and quartz substrates has a TD linear expansion coefficient of lower than 10×10⁻⁶ cm/cm/° C. and an MD linear expansion coefficient of 10-20×10⁻⁶ cm/cm/° C. As described above, the process described specifically in Patent Publication 2 gives an aromatic polyimide film showing such low linear expansion ratios (that is, low thermal expansion ratios). It should be noted that the specifically described process is carried out under such conditions that the polyamic acid (polyimide precursor) is prepared using two carboxylic acid components and two diamine components, that the stretching procedure is carried out by the two step stretching steps, that is, stretching in the running direction and stretching in the transverse direction, and that the second stretching in the transverse direction is made on the substantially imidized polyimide film (this means that the polyimide film is substantially cured by heating procedure at 270° C.). The procedure of stretching the substantially cured polyimide film cannot be carried out with no difficulty in industry.

### SUMMARY OF THE INVENTION

Accordingly, it is an object of the present invention to provide an industrially utilizable process for producing an aromatic polyimide film having a linear expansion coefficient in transverse direction (TD) lower than a linear expansion coefficient in machine direction (MD). In particular, the invention has an object to provide an industrially utilizable process for producing an aromatic polyimide film having a TD linear expansion coefficient of lower than 10×10⁻⁶ cm/cm/° C. and an MD linear expansion coefficient of 10-20×10⁻⁶ cm/cm/° C.

The present inventors have found that the object of the invention can be achieved by performing the process for production of an aromatic polyimide film which comprises the steps in order of: spreading an aromatic polyimide precursor solution in which an aromatic polyimide precursor is dissolved in a solvent on a surface of a running continuous support to form an aromatic polyimide precursor solution layer; heating the aromatic polyimide precursor solution layer to removing a portion of the solvent by evaporation, thereby converting it to a self-supporting aromatic polyimide precursor layer; separating the self-supporting aromatic polyimide precursor layer from the continuous support, thereby obtaining a self-supporting aromatic polyimide precursor film; stretching the self-supporting aromatic polyimide precursor film under heating; and heating the stretched self-supporting aromatic polyimide precursor film at an elevated temperature, thereby converting it to a self-supporting aromatic polyimide film under the following conditions:

the self-supporting aromatic polyimide precursor film is prepared to have a specific solvent content (i.e., 25-45 wt. %); the self-supporting aromatic polyimide precursor film is stretched under insufficiently imidized condition (i.e., imidation ratio: 5-40%); the self-supporting aromatic polyimide precursor film is stretched in transverse direction at a temperature of 80-240° C.; and the thus stretched self-supporting aromatic polyimide precursor film is converted to a self-supporting aromatic polyimide film by heating the precursor film at elevated temperatures (temperatures in the range of 350 to 580° C.)

Accordingly, the present invention resides in a process for producing aromatic polyimide film having a linear expansion coefficient in transverse direction lower than a linear expansion coefficient in machine direction, comprising the steps in order of: spreading an aromatic polyimide precursor solution in which an aromatic polyimide precursor is dissolved in a solvent on a surface of a running continuous support to form an aromatic polyimide precursor solution layer; heating the aromatic polyimide precursor solution layer to removing a portion of the solvent by evaporation, thereby converting it to a self-supporting aromatic polyimide precursor layer; separating the self-supporting aromatic polyimide precursor layer from the continuous support, thereby obtaining a self-supporting aromatic polyimide precursor film; stretching the self-supporting aromatic polyimide precursor film under heating; and heating the stretched self-supporting aromatic polyimide precursor film at an elevated temperature, thereby converting it to a self-supporting aromatic polyimide film,

wherein the self-supporting aromatic polyimide precursor film has a solvent content in the range of 25 to 45 wt. % and an imidation ratio in the range of 5 to 40%, the step of stretching the self-supporting aromatic polyimide precursor film under heating is performed by stretching the self-supporting aromatic polyimide precursor film in transverse direction initially at a temperature in the range of 80 to 240° C., and the step of converting the stretched self-supporting aromatic polyimide precursor film to a self-supporting aromatic polyimide film is performed at temperatures in the range of 350 to 580° C.

In the invention, the linear expansion coefficient means a linear expansion coefficient measured in the plane direction, and the heating temperatures mean temperatures measured on the film surface.

### EFFECTS OF THE INVENTION

The aromatic polyimide film having a linear expansion coefficient in transverse direction (TD) lower than a linear expansion coefficient in machine direction (MD) can be reliably produced in industry with no difficult by utilizing the process of the invention. In particular, the aromatic polyimide film having a TD linear expansion coefficient lower than 10×10⁻⁶ cm/cm/° C. (in particular, in the range of 3×10⁻⁶ cm/cm/° C. to 7×10⁻⁶ cm/cm/° C.) and an MD linear expansion coefficient in the range of 10 to 20×10⁻⁶ cm/cm/° C. under such condition that the difference between the TD linear expansion coefficient and MD linear expansion coefficient is within 16×10⁻⁶ cm/cm/° C. by the process of invention.

In addition, since the aromatic polyimide film, produced by the process of the invention shows low hygroscopicity, the aromatic polyimide film is advantageously employed as a substrate of an electronic part to be mounted on electronic devices and display devices employed under high humidity conditions.

The aromatic polyimide film having a linear expansion coefficient in transverse direction (TD) lower than a linear expansion coefficient in machine direction (MD) which is obtainable by the process of the invention can be favorably employed for preparing a composite laminate for the manufacture of a printed wiring board, by placing a metal film such as a copper film on one surface or both surfaces of the polyimide film via an adhesive layer. The thus prepared composite laminate can be processed to etch out a portion of the metal layer to form metal wiring extending in the machine direction (MD) of the film, thereby forming the printed wiring board. The printed wiring board is specifically favorably employable for manufacturing a printed wiring board equipped with electronic devices such as IC chips, by connecting the wiring of electronic devices to the wiring of the printed wiring board in such manner that both wirings are aligned with each other.

Thus, the metal-laminated composite and printed wiring board prepared using the aromatic polyimide film having a linear expansion coefficient in transverse direction (TD) lower than a linear expansion coefficient in machine direction (MD) which is obtainable by the process of the invention can be favorably employed as a metal wiring substrate for FPC, TAB, COF and like, an insulating substrate material, a material covering electronic devices such as IC chips, and a substrate for liquid crystal display, organic electroluminescence display, electronic paper and solar battery.

In addition, the aromatic polyimide film obtained by the process of the invention can be favorably employed for the purpose of mounting resistances and capacitors thereon.

### PREFERRED EMBODIMENTS OF THE INVENTION

Preferred embodiments of the process of production of an aromatic polyimide film according to the invention are described below.

(1) The step of stretching the self-supporting aromatic polyimide precursor film in transverse direction is performed at a stretch ratio in the range of 1.01 to 1.12.

(2) The step of stretching the self-supporting aromatic polyimide precursor film in transverse direction is performed at a stretch ratio in the range of 1.01 to 1.09.

(3) The step of stretching the self-supporting aromatic polyimide precursor film in transverse direction is performed at a temperature in the range of 80 to 240° C. for a period of at least 2 minutes.

(4) The step of stretching the self-supporting aromatic polyimide precursor film in transverse direction is performed at a temperature in the range of 90 to 160° C. for a period of at least 2 minutes.

(5) The step of stretching the self-supporting aromatic polyimide precursor film in transverse direction is terminated at a temperature in the range of 80 to 300° C.

(6) The aromatic polyimide precursor solution is obtained by reaction of a carboxylic component comprising 3,3′,4,4′-biphenyltetracarboxylic acid compound as a predominant ingredient and a diamine component comprising p-phenylene diamine as a predominant ingredient in an organic solvent.

(7) The step of stretching the self-supporting aromatic polyimide precursor film in transverse direction is performed by fixing both side ends of the film.

(8) The fixing of the both side ends of the self-supporting aromatic polyimide precursor film is performed using pin tenters, clip tenters, or chucks.

(9) The self-supporting aromatic polyimide precursor film is produced to have a solvent content in the range of 30 to 41 wt. %.

(10) The self-supporting aromatic polyimide precursor film is produced to have an imidation ratio in the range of 7 to 18%.

Details of the process for production of an aromatic polyimide film according to the invention are described below in more detail.

### 1. Preparation of Aromatic Polyimide Precursor Solution

The solution of aromatic polyimide precursor (may be referred to as polyamic acid or polyamide acid) can be prepared by polymerizing an aromatic tetracarboxylic acid compound and an aromatic diamine compound in an organic solvent. The preparation of the aromatic polyimide precursor solution is well known.

Examples of the aromatic tetracarboxylic acid compounds include 3,3′,4,4′-biphenyltetracarboxylic dianhydride (s-BPDA), 2,3,3′,4′-biphenyltetracarboxylic dianhydride (a-BPDA), pyromellitic dianhydride, 3,3′,4,4′-benzophenonetetracarboxylic dianhydride, and 3,3′,4,4′-diphenylethertetracarboxylic dianhyride. These aromatic carboxylic acid compounds can be used alone or in combination.

Examples of the aromatic diamine compounds include p-phenylenediamine (PPD), 1,3-diaminobenzene, 2,4-toluenediamine, benzidine, 4,4′-diamino-3,3′-dimethylbiphenyl, and 4,4′-diamino-2,2′-dimethylbiphenyl. These aromatic diamine compounds can be used alone or in combination.

The organic solvent employable for the polymerization of the aromatic tetracarboxylic acid compound and an aromatic diamine compound can be a well known polar organic solvent in which the aromatic polyimide precursor can be dissolved. The organic solvent can be N-methyl-2-pyrrolidone, N,N-dimethylformamide, N,N-dimethylacetamide, or N,N-diethylacetamide.

The aromatic polyimide precursor solution preferably has a polyimide concentration (content) in the range of 5 to 30 wt. %, more preferably 10 to 25 wt. %, particularly preferably 15 to 20 wt. %. The aromatic polyimide precursor solution preferably has a viscosity (solution viscosity) in the range of 100 to 10,000 poises, more preferably 400 to 5,000 poises, particularly preferably 1,000 to 3,000 poises.

The aromatic polyimide precursor solution may contain one or more known additives such as an imidizing agent (imidizing catalyst), an organic phosphorus-containing compound, inorganic fine particles, and organic fine particles.

An aromatic polyimide precursor which is particularly preferably employable in the process for producing an aromatic polyimide film according to the invention is an aromatic polyimide precursor prepared from s-BPDA as the aromatic tetracarboxylic acid compound and PPD as the aromatic diamine compound. Each of s-BPDA and PPD can be employed in combination with other aromatic tetracarboxylic acid compounds and other aromatic diamine compounds such as those described hereinbefore, respectively. However, it is preferred that other compounds are employed with s-BPDA and PPD in relatively small amounts.

### 2. Preparation of Aromatic Polyimide Precursor Solution Layer

The aromatic polyimide precursor solution prepared by polymerization of an aromatic tetracarboxylic acid compound and an aromatic diamine compound in an organic solvent is subsequently supplied into a die of a film-forming apparatus and excluded from a die lip of the die so that the precursor solution can spread on a running or rotating support (e.g., endless belt or drum) in the form of a thin layer. Thus, the aromatic polyimide precursor solution layer is formed on the support.

### 3. Preparation of Self-Supporting Aromatic Polyimide Precursor Layer

The aromatic polyimide precursor solution layer formed on the running or rotating support is subsequently conveyed into a casting furnace and heated for performing removal of a portion of the solvent and partial imidization, to form on the support a self-supporting aromatic polyimide precursor layer which has a solvent content in the range of 25 to 45 wt. % (preferably in the range of 27 to 43 wt. %, more preferably 30 to 41 wt. %, most preferably 33 to 40 wt. %) and an imidization ratio in the range of 5 to 40% (preferably in the range of 5.5 to 35%, further preferably 6.0 to 22%, more preferably 6.5 to 20%, most preferably 7 to 18%).

The self-supporting aromatic polyimide precursor layer is formed on the support, preferably to give an aromatic polyimide film having a thickness in the range of 5 to 120 μm (further preferably in the range of 6 to 50 μm, more preferably 7 to 25 μm, most preferably 8 to 15 μm) after the heating and stretching are performed afterwards.

The aromatic polyimide precursor solution layer can be coated with a surface treating agent such as a coupling agent (e.g., silane-coupling agent) or a chelating agent on its surface, before or after the subsequent heating.

### 4. Preparation of Self-Supporting Aromatic Polyimide Precursor Film

The self-supporting aromatic polyimide precursor layer is subsequently separated from the support to give a self-supporting aromatic polyimide precursor film.

### 5. Stretching of Self-Supporting Aromatic Polyimide Precursor Film

The self-supporting aromatic polyimide precursor film separated from the support is subsequently stretched in the transverse direction (TD, the direction perpendicular to the machine direction (MD), namely, the direction of movement of the running or rotating aromatic polyimide precursor layer) under heating. The stretching in the transverse direction is preferably performed at an initial temperature of 80 to 240° C. (further preferably 85 to 200° C., more preferably 90 to 160° C., furthermore preferably 95 to 140° C., most preferably 100 to 120° C.). The heating is preferably continued at least about 2 minutes (generally within 60 minutes) at a temperature in the abovementioned range. The stretching can be further continued but is preferably terminated at a temperature of 300° C. or lower (more preferably 295° C. or lower, most preferably 290° C. or lower). This means that the stretching is preferably terminated before the polyimide precursor film is not converted to a highly imidized polyimide film containing essentially no solvent.

The stretching in the transverse direction can be preferably performed under such condition that both side ends of the film are fixed using known fixing means such as pin tenters, clip tenters or chucks. The stretching ratio is generally in the range of 1.01 to 1.12, preferably 1.04 to 1.11 or 1.01 to 1.09, further preferably 1.05 to 1.10, more preferably 1.06 to 1.10, most preferably 1.07 to 1.09. Nevertheless, a stretching ratio of 1.01 to 1.20 may be adopted in certain cases. The stretching rate is generally in the range of 1%/min. to 20%/min., preferably in the range of 2%/min. to 10%/min. The stretching can be performed in various patterns, such as stretching giving a fixed stretching ratio, successive stretching, stretching slowly at a predetermined stretching ratio, stretching slowly at varying stretching ratios, and a combination of these stretching modes.

### 6. Conversion of Stretched Self-Supporting Aromatic Polyimide Precursor Film to Self-Supporting Aromatic Polyimide Film

The self-supporting aromatic polyimide precursor film stretched in the above-mentioned manner or under stretching is subsequently converted to the desired self-supporting aromatic polyimide film having a linear expansion coefficient in transverse direction (CTE-TD) lower than a linear expansion coefficient in machine direction (CTE-MD) by heating the precursor film at elevated temperatures (in the range of 350 to 580° C.).

The thus produced aromatic polyimide film preferably has one of the below-mentioned relationships between CTE-TD and CTE-MD. The aromatic polyimide film having the below-mentioned relationships can be produced by adjusting the transverse stretching conditions, the solvent content and imidization ratio of the precursor film under stretching and heating condition for the stretching procedure.

(CTE-MD)>(CTE-TD)≧(CTE-MD)−15 ppm/° C. 1)

(CTE-MD)−1 ppm/° C.≧(CTE-TD)≧(CTE-MD)−14 ppm/° C. 2)

(CTE-MD)−2 ppm/° C.≧(CTE-TD)≧(CTE-MD)−13 ppm/° C. 3)

(CTE-MD)−4 ppm/° C.≧(CTE-TD)≧(CTE-MD)−12 ppm/° C. 4)

(CTE-MD)−6 ppm/° C.≧(CTE-TD)≧(CTE-MD)−11 ppm/° C. 5)

(CTE-MD)−8 ppm/° C.≧(CTE-TD)≧(CTE-MD)−14 ppm/° C. 6)

The unit “ppm/° C.” means “×10⁻⁶ cm/cm/° C”.

The polyimide film produced by the invention can give a polyimide/metal composite laminate or a polyimide/ceramic composite laminate by laminating a metal layer or a ceramic layer on the polyimide film directly or via an adhesive layer.

To the polyimide film produced by the invention can be connected chip devices such as IC chips directly or using adhesive.

The lamination of a metal layer directly on the polyimide film can be performed in the following manner:

1) depositing a metal layer on the polyimide film by a metallizing procedure such as sputtering or metal deposition; and

2) combining the polyimide film and a metal foil by thermal pressing or thermal fusing under atmospheric pressure or increased pressure.

The metallizing procedure is a procedure for forming a metal layer but differs from metal-plating and lamination of a metal foil, and can be performed by vacuum deposition, sputtering, ion plating, or application of electron beam.

The metallizing procedure can be performed using a metal such as copper, nickel, chromium, manganese, aluminum, iron, molybdenum, cobalt, tungsten, vanadium, titanium, tantalum, their alloy. Alternatively, a metal compound such as a metal oxide or a metal carbide can be used. The metal layer formed by the metallizing procedure can have an optionally selected thickness. The thickness is generally in the range of 1 to 500 nm, more preferably 5 to 200 nm. The metal layer can be a single metal layer or a multiple layer such as a composite layer comprising two layers or three or more layers.

On the metal layer of the metal-laminated polyimide film can be formed a plated metal layer such as a copper layer or a tin layer by the conventional wet plating procedure such as electro-plating or electroless plating. The plated metal layer such as a plated copper layer preferably has a thickness in the range of 1 to 40 μm.

When a metal foil such as a copper foil is laminated on the polyimide film directly or via an adhesive layer, the metal foil can have an optionally selected thickness, but preferably has a thickness of about 1 to 50 μm, more preferably about 2 to 20 μm. The metal foil can be optionally selected, and can be a rolled copper foil, an electrolytic copper foil, a copper alloy foil, an aluminum foil, a stainless foil, a titanium foil, an iron foil or a nickel foil.

The adhesive can be selected from the known adhesives in consideration of insulating characteristics and adhesion characteristics. The adhesive can be ACF (asymmetric conductive adhesive The adhesive can be thermoplastic or thermosetting. The adhesive can comprise a polyimide adhesive, a polyimide adhesive, a polyimidoamide adhesive, an acrylic adhesive, an epoxy adhesive, a urethane adhesive, or a their combination. The acrylic adhesive, epoxy adhesive, urethane adhesive, and polyimide adhesive are particularly preferred.

### EXAMPLES

In the following examples, the solvent content and imidization ratio of the self-supporting aromatic polyimide precursor film and the linear expansion coefficient and expansion coefficient after moisture absorption were determined in the below-described methods.

1) Solvent Content

Initially, the weight (W1) of the polyimide precursor film (specimen) is determined. The weighed polyimide precursor film is placed in an oven and heated at 400° C. for 30 minutes. The weight (W2) of the heated film is then determined.

The solvent content (%) of the film is calculated using the formula: [(W1−W2)/W1]×100.

2) Imidization Ratio

The A plane (that was kept in contact with a support in the film preparation) and B plane (that was kept in contact with air in the film preparation) of an aromatic polyimide precursor film and further the A plane (corresponding to the above-identified A plane) and B plane (corresponding to the above-identified B plane) of the polyimide film produced by subjecting the aromatic polyimide precursor film to the imidization processing (heating at 480° C. for 5 minutes) are subjected to IR-ATR measurement using FT-IR-4100 available from Jasco Corporation and ZnSe. Further, a peak area (X1) in the area between 1560.13 cm⁻¹ and 1432.85 cm⁻¹ and a peak area (X2) between 1798.30 cm⁻¹ and 1747.19 cm⁻¹ are calculated.

Subsequently, an area ratio (X1/X2) is calculated for the A plane and B plane of each film, to give the following area ratios:

Area ratio on the A plane of the polyimide precursor film: a1

Area ratio on the B plane of the polyimide precursor film: b1

Area ratio on the A plane of the polyimide film: a2

Area ratio on the B plane of the polyimide film: b2

The imidization ratio of the polyimide precursor film can be calculated using the following equation:

Imidization ratio (%)=(a1/a2+b1/b2)×50

3) Linear Expansion Coefficient

An average linear expansion coefficient is determined in the temperature range of 50 to 200° C. at a temperature elevating rate of 20° C.min., using TMA/SS 6100 (available from Seiko Instrument Co., Ltd.).

4) Expansion Coefficient After Moisture Absorption

The polyimide film is cut to give a square specimen (8 cm for MD×8 cm for TD). The specimen is kept at 23° C., 40% RH for 24 hours and is measured on its length of transversion direction (TD) (Y₁, unit: mm), and then kept at 23° C., 80% RH for 24 hours and measured on its length of transversion direction (TD) (Y₂ in terms of mm).

The expansion coefficient (Y) after moisture absorption is calculated using the following equation:

Y=(Y₂−Y₁)/(difference of RH (40)×Y₁)

### Examples 1-11 and Comparison Example 1

(1) Preparation of Continuous Self-Supporting Polyimide Precursor Film

In dimethylacetamide (DMAc: solvent) were dissolved s-BPDA and PPD in equimolar amounts and warmed under stirring to give a polyimide precursor solution (solution viscosity at 30° C.: 1,800 poises, polyimide precursor concentration: 18 wt. %). The polyimide precursor solution was extruded from a die slit to spread on a surface of a running stainless endless belt (support), so as to form a polyimide precursor solution layer. The thus formed polyimide precursor solution layers were heated to temperatures in the range of 120° C. to 140° C. on the supports to give self-supporting polyimide precursor layers having different solution contents and imidization ratios. The self-supporting polyimide precursor layers were separated from the support to give continuous self-supporting polyimide precursor films. The solvent contents and imidization ratios of self-supporting polyimide precursor films prepared in Examples 1 to 11 and Comparison Example are set forth in the below-given Table 1. The self-supporting polyimide precursor films having different solvent contents and imidization ratios in Examples 1-11 and Comparison Example were prepared by varying the heating temperature and heating period.

(2) Stretching of Continuous Self-Supporting Polyimide Precursor Film Under Heating

The continuous self-supporting polyimide precursor film was fixed at all ends in both of the transverse direction (TD) and machine direction (MD). The thus fixed precursor film was passed through three heating zones heated to different temperatures. In Examples 1-11, the continuous self-supporting polyimide precursor film was stretched in the transverse direction under the below-given conditions (stretching ratio is set forth in Table 1) when the film was passed in the heating zones. In Comparison Example 1, the continuous self-supporting polyimide precursor film was not stretched when it was passed in the heating zones:

Stretching a: one min. at 105° C.-one min. at 150° C.-one min. at 280° C.

Stretching b: one min. at 105° C.-one min. at 150° C.-one min. at 230° C.

(3) Conversion of Continuous Self-Supporting Polyimide Precursor Film to Continuous Polyimide Film

The polyimide precursor film subjected to the processing described in (2) above was subsequently heated at 350° C. for 2 minutes, without stretching the film, to complete imidization. Thus, a continuous polyimide film having a thickness of 35 μm was produced.

The linear expansion coefficients (MD, TD, units: ppm/° C.) and expansion coefficient in the transverse direction after moisture absorption (unit: ×10⁻⁶/% RH) are presented in Table 1.

TABLE 1

| | Solvent | Imidiz- | Stretching | Linear | | Expansion |
|---|---|---|---|---|---|---|
| | content | ation | condition | expansion | | (moisture |
| Example | (wt. %) | ratio (%) | (ratio) | MD | TD | absorption) |
| 1 | 37.0 | 15.3 | a (1.082) | 16 | 5.5 | 4.2 |
| 2 | 34.5 | 12.7 | a (1.072) | 16 | 5.8 | 4.4 |
| 3 | 34.0 | 11.6 | a (1.078) | 16 | 6.2 | 4.6 |
| 4 | 39.1 | 7.8 | a (1.083) | 16 | 6.3 | 4.7 |
| 5 | 39.8 | 10.2 | a (1.084) | 16 | 6.4 | 4.8 |
| 6 | 38.9 | 8.5 | a (1.074) | 16 | 6.8 | 5.0 |
| 7 | 34.0 | 11.6 | b (1.075) | 16 | 6.9 | 5.1 |
| 8 | 27.9 | 21.7 | a (1.045) | 16 | 9.7 | 6.7 |
| 9 | 41.9 | 13.7 | a (1.077) | 16 | 10.5 | 7.2 |
| 10 | 42.4 | 5.6 | a (1.078) | 16 | 11.0 | 7.5 |
| 11 | 29.1 | 23.6 | b (1.042) | 16 | 12.9 | 8.7 |
| Com. 1 | 37.9 | 6.4 | a (—) | 16 | 17.6 | 11.5 |

Remarks:

Stretching ratio: (A-B)/B [A: length in the transverse direction after stretching is made, B: length in the transverse direction before stretching is made]

Unit of linear expansion: ppm/° C. (×10⁻⁶ cm/cm/° C.)

Unit of expansion (moisture absorption): −10⁻⁶/% RH

The results given in Table 1 indicate the following:

(1) Under the conditions adopted in Examples 1-7, a polyimide film having a linear expansion coefficient of 5 to 7 ppm/° C. in the transverse direction and a coefficient of expansion after moisture absorption of 6×10⁻⁶/% RH or less is produced;

(2) Under the conditions adopted in Example 8, a polyimide film having a linear expansion coefficient of 9 to 10 ppm/° C. in the transverse direction and a coefficient of expansion after moisture absorption of 6×10⁻⁶/% RH to 7×10⁻⁶/% RH is produced;

(3) Under the conditions adopted in Examples 9 and 10, a polyimide film having a linear expansion coefficient of higher than 10 ppm/° C. but not higher than 12 ppm/° C. in the transverse direction and a coefficient of expansion after moisture absorption of 7×10⁻⁶/% RH to 8×10⁻⁶/% RH is produced;

(4) Under the conditions adopted in Example 11, a polyimide film having a linear expansion coefficient of higher than 12 ppm/° C. but not higher than 13 ppm/° C. in the transverse direction and a coefficient of expansion after moisture absorption of 8×10⁻⁶/% RH to 9×10⁻⁶/% RH is produced.

### Example 12

### Production of Polyimide Film Composite Laminate

A polyimide film composite laminate having an adhesive layer on one surface (A plane) was produced by forming an adhesive layer on the polyimide film prepared in Example 1.

### Example 13

### Production of Polyimide/Metal Composite Laminate and Manufacture of Wiring Board (1)

On the adhesive layer of the polyimide film composite laminate produced in Example 12 was placed a rolled copper foil, and both are heated together to produce a polyimide/copper composite laminate. A portion of the copper foil of the polyimide/copper composite laminate was etched out, to manufacture a wiring board having a copper wiring (wiring pitch: 60 μm) in the longitudinal direction (MD) to which chip devices such as IC chips could be connected.

### Example 14

### Production of Polyimide/Metal Composite Laminate and Manufacture of Wiring Board (2)

The polyimide film composite produced in Example 1 was subjected on its one surface (A plane) to DC sputtering with a power of 8.5 kW/m², to form a copper thin film on the surface. On the copper thin film was placed a copper layer of 8 μm thick by plating under a current density of 280 A/m², to give a polyimide/copper composite laminate. A portion of the copper foil of the polyimide/copper composite laminate was etched out, to manufacture a wiring board having a copper wiring (wiring pitch: 60 μm) in the longitudinal direction (MD) to which chip devices such as IC chips could be connected.

### Example 15

### Production of Polyimide/Metal Composite Laminate and Manufacture of Wiring Board (3)

The procedures of Example 14 were repeated except that a nickel/chromium alloy thin layer (Cr content: 15 wt. %) of 5 nm thick was placed on the surface of the polyimide in advance of the formation of the copper thin layer by the sputtering.

1. (canceled)

2. An aromatic polyimide film having a linear expansion coefficient in the range of 3×10⁻⁶ cm/cm/° C. to 7×10⁻⁶ cm/cm/° C. in the transverse direction which is lower than a linear expansion coefficient in the machine direction and a coefficient of expansion after moisture absorption of 6×10⁻⁶/% RH or less, wherein the coefficient of expansion after moisture absorption is determined by calculation using the following equation:
Y=(Y₂−Y₁)/40×Y₁
wherein Y is the coefficient of expansion after moisture absorption, Y₁ and Y₂ both are lengths of the transverse direction in terms of mm, determined under the below-described conditions, and 40 is the difference of RH:
the polyimide film is cut to give a square specimen of 8 cm×8 cm and kept at 23° C., 40% RH for 24 hours and is measured on its length of the transverse direction to give Y₁, and then kept at 23° C., 80% RH for 24 hours and is measured on its length of the transverse direction to give Y₂.

3. The aromatic polyimide film of claim 2, in which the polyimide film is prepared from a carboxylic acid component comprising 3,3′,4,4′-biphenyltetracarboxylic acid dianhydride as a predominant ingredient and a diamine component comprising p-phenylene diamine as a predominant ingredient.

4. A process for producing an aromatic polyimide film of claim 2, which comprises the steps in order of: spreading an aromatic polyimide precursor solution in which an aromatic polyimide precursor is dissolved in a solvent on a surface of a running continuous support to form an aromatic polyimide precursor solution layer; heating the aromatic polyimide precursor solution layer to remove a portion of the solvent by evaporation, thereby converting it to a self-supporting aromatic polyimide precursor layer; separating the self-supporting aromatic polyimide precursor layer from the continuous support thereby obtaining a self-supporting aromatic polyimide precursor film; stretching the self-supporting aromatic polyimide precursor film under heating; and heating the stretched self-supporting aromatic polyimide precursor film at an elevated temperature, thereby converting it to a self-supporting aromatic polyimide film,
wherein the self-supporting aromatic polyimide precursor film has a solvent content in the range of 33 to 40 wt. % and an imidation ratio in the range of 6.0 to 22%, the step of stretching the self-supporting aromatic polyimide precursor film under heating is performed by stretching the self-supporting aromatic polyimide precursor film in the transverse direction initially at a temperature in the range of 80 to 200° C. and is terminated at a temperature in the range of 80 to 300° C., and the step of converting the stretched self-supporting aromatic polyimide precursor film to the self-supporting aromatic polyimide film is performed at a temperature in the range of 350 to 580° C.

5. The process of claim 4, in which the step of stretching the self-supporting aromatic polyimide precursor film in the transverse direction is performed at a stretch ratio in the range of 1.01 to 1.12.

6. The process of claim 4, in which the step of stretching the self-supporting aromatic polyimide precursor film in the transverse direction is performed at a stretch ratio in the range of 1.01 to 1.09.

7. The process of claim 4, in which the step of stretching the self-supporting aromatic polyimide precursor film in the transverse direction is performed at a temperature in the range of 80 to 200° C. for a period of at least 2 minutes.

8. The process of claim 4, in which the step of stretching the self-supporting aromatic polyimide precursor film in the transverse direction is performed at a temperature in the range of 90 to 160° C. for a period of at least 2 minutes.

9. The process of claim 4, in which the step of stretching the self-supporting aromatic polyimide precursor film in the transverse direction is performed by fixing both side ends of the film.

10. The process of claim 9, in which the fixing the both side ends of the self-supporting aromatic polyimide precursor film is performed using pin tenters, clip tenters, or chucks.

11. The process of claim 4, in which the self-supporting aromatic polyimide precursor film is produced to have an imidation ratio in the range of 7 to 18%.
